(19) United States
(12) Patent Application Publication
(10) Pub. No.: US 2025/0071485 A1
(43) Pub. Date: Feb. 27, 2025

(54) METHODS AND DEVICES FOR ADJUSTING AUDIO SOURCES OF A BINAURAL HEARING AID SYSTEM

(71) Applicant: Oticon A/S, Smørum (DK)

(72) Inventors: Ross HARVEY, Smørum (DK); Rasmus Lund BENDTSEN, Smørum (DK); Rasmus Lundby PEDERSEN, Smørum (DK); Morten VINDING, Smørum (DK); Henrik Damborg HALD, Smørum (DK)

(21) Appl. No.: 18/795,233

(22) Filed: Aug. 6, 2024

(30) Foreign Application Priority Data
Aug. 21, 2023 (EP) 23192434.1

(51) Int. Cl. H04R 25/00

(52) U.S. Cl. CPC H04R 25/407; H04R 25/552; H04R 25/554; H04R 2225/41; H04R 2225/55

(57) ABSTRACT

Disclosed herein are embodiments of a method for adjusting audio sources of a binaural hearing aid system. In particular, embodiments of the method can include determining signal strength from two hearing aids and comparing the differences in the signal strength. Further, the method utilizes accelerometer data for determination of head turns of a user.

### TECHNICAL FIELD

The present application relates to the field of hearing aids and binaural hearing aid systems, in particular methods of improving the binaural hearing aid system experience for a user.

### SUMMARY

Methods for adjusting audio sources of a binaural hearing aid system: In an aspect of the present application, a method for adjusting audio sources of a binaural hearing aid system is disclosed. The method includes obtaining, by a first hearing aid, an audio signal from a first audio source. The method includes determining, by the first hearing aid, a first signal strength of the audio signal. The method includes obtaining, by a second hearing aid, the audio signal from the first audio source. The method includes determining, by the second hearing aid, a second signal strength of the audio signal. The method includes obtaining, by the first hearing aid and/or the second hearing aid, accelerometer data. In accordance with the difference between the first signal strength being and the second signal strength meeting the difference criterion and the accelerometer data being indicative of movement of the first hearing aid and/or the second hearing aid, changing the at least one audio parameter in the first hearing aid and the second hearing aid. Changing the at least one audio parameter comprises attenuating the audio signal of the first audio source. Changing the at least one audio parameter comprises increasing gain of a second audio signal of a second audio source.

Advantageously, embodiments of the disclosed method can allow for a user of the binaural hearing aid system to have improved awareness of an environment which may utilize at least two different audio sources, such as a streaming source and a hearing aid environment or two streaming sources. For example, the disclosed method(s) can allow for a user to seamlessly transition from listening to a streaming source to that of the environment around the user, and vice-versa. The method can advantageously utilize differences in signal strengths between two hearing aids for more accurate determination of the best audio parameters to use. Further, embodiments of the disclosed method can increase speech understanding and awareness in streaming scenarios when the user is focused on their surroundings rather than the streaming source. In certain situations, the disclosed method can lead to less social isolation for the end-user when using assistive streaming devices.

It is possible to use sensor-derived motion data, for example from an accelerometer, gyroscope, or magnetometer, to sense a head movement of a hearing aid user (e.g., of a binaural hearing aid system). However, alone it may not be possible to infer the direction of head movement. In addition, all the current systems have the drawback that they do not know whether the user is looking at their screen or streaming source, or looking away, and thus it is not possible to set the true reference point for where the streamed sound should come from. Systems today generally reset the spatial orientation to “in front of the user” if they have not moved for some time. This is because the headphones or hearing instruments do not have a way of knowing in which direction the TV or streaming source is placed. This non-ideal solution means that the system is inaccurate, and the spatial sound will drift and move over time.

Embodiments of the disclosed method can incorporate the use of an accelerometer obtaining accelerometer data along with the determination of signal strength. This combination can be advantageous for determining whether a user is moving their head, which may be an indication of a change of audio source. The combination of the accelerometer data and the signal strength can provide significant synergistic advantages for properly determining the audio source that a user wishes to listen to (e.g., to have increased gain on) over the use of any individual systems. The combination can be advantageous for validating head turns, and/or for understanding if the head turn is to a particular direction (e.g., to the left, to the right).

Manufacturers of commercial wireless earbuds are including inertial measurement units (IMU) in their devices. The key driver for high quality spatial audio in the IMU is the gyroscope, used to measure the 3D rotation angles of the user's head with high precision. However, gyroscopes are naturally prone to bias instabilities which leads to measurement drift over time, effectively rendering the spatial audio processing inaccurate after a period, unless otherwise corrected. The methods described herein may advantageously be utilised to correct the slow drift, and re-reference the measured head-rotation angles.

Moreover, in situations where only an accelerometer is used, there were frequent “false positives”, when the movement sensor was triggered when looking back at the television, making the television volume low just as the user looks back to it.

In one or more examples, the disclosed method(s) can be used for the determination of a streaming source using left-right (L-R) signal analysis (e.g., from a first hearing aid and a second hearing aid). For example, streaming sources, such as Bluetooth, can use a 2.4 GHz carrier frequency to transmit data. The signal path may have line-of-sight between the source and the receivers, in this case two head-mounted hearing-instruments, but it may also be partially blocked by the hearing aid user's head if the user is not looking directly at the streaming source, creating a shadowing effect. Typically, one of the two hearing aids in a binaural hearing aid system will always be in line-of-sight, while the other will receive the transmitted radio-frequency waves as surface waves that follows the curvature of the user's head and/or by scattering and reflections from a surrounding environment. Becoming a surface wave, some of the waves' energy will be lost to refraction and absorption by the user's head, so only a fraction of the original wave will reach the blocked hearing aid. The amount signal energy lost will depend on the relative angle between the user's head and the signal source and this can be used to help estimate the user's head's orientation relative to the source.

By measuring the signal strength of an audio signal on receipt into the hearing aid (e.g., the first signal strength and the second signal strength), and then comparing the signal strength (e.g., signal quality, difference between the second signal strength and the first signal strength) of the two hearing aids, the method can advantageously determine whether the user is looking at a television, for example, or if the television is orientated to the right or left, and appropriately change at least one audio parameter in both the first hearing aid and the second hearing aid. Moreover, embodiments of the disclosure can avoid false positives, such as changing the at least one audio parameter without needing to.

The method can include obtaining (e.g., receiving), by a first hearing aid, an audio signal from a first audio source. The first hearing aid can be, for example, a hearing aid configured to be used with a left ear of a user (e.g., a left hearing aid, HAL). Obtaining the audio signal can include obtaining the audio via a microphone of the first hearing aid and converting the audio received via the microphone into the audio signal. Obtaining the audio signal can include obtaining the audio via a wireless communication. Obtaining the audio signal can include obtaining the audio via an antenna. The antenna can be used for wireless communication. A wireless communication includes, for example, Bluetooth. The audio signal can be representative of audio from the first audio source.

As used herein, “audio” and “audio signal” can be used interchangeably. The audio signal may be a digital and/or electronic signal representative of an audio. For example, once the audio is obtained by the first hearing aid and/or the second hearing aid via a microphone or an antenna, it can be converted to an electronic signal representing the audio (e.g., audio signal), such as by one or more processors. Further, the audio signal can undergo one or more processing steps. The audio signal can then be converted to an output audio for outputting to a user. When certain steps of the method are discussed as applying to the audio, they may be considered as applying to an audio signal representing the audio.

The first audio source can be a first streaming audio source. In other words, the first audio source can be an audio source connected to the first hearing aid via a wireless communication (e.g., via an antenna in the first hearing aid). The first audio source can be an external device (e.g., third party device, remote device). For example, the first audio source can include one or more of: a television, a mobile telephone, a computer, a tablet, a TV adapter, an EduMic, and a smart phone. The first hearing aid can obtain the audio signal from the first streaming audio source via wireless communication, such as Bluetooth. The first streaming audio source can be any device that actively streams an audio signal to the first hearing aid.

In the case of a first streaming audio source, both the first hearing aid and the second hearing aid can obtain the audio signal from the first audio source. In certain examples, there may be minor variations of the audio signal obtained by the first hearing aid and the audio signal obtained from the second hearing aid. The first hearing aid can obtain the audio signal from the first audio source separately from the second hearing aid obtaining the audio signal from the first audio source. In other words, the first hearing aid and the second hearing aid may both be separately connected to the first audio source. The audio signal obtained by the first hearing aid may be indicative of the same audio as the audio signal obtained by the second hearing aid. For example, if the first audio source is a television, the first hearing aid and the second hearing aid obtain the audio signal of the current audio being output by the television.

The first audio source can be a first environmental audio source. For example, the first audio source can be producing the audio in the environment around a user of the hearing aid. The first hearing aid can obtain the audio from the first audio source via one or more microphones (e.g., via a microphone) in the first hearing aid. This can be understood as being a “standard” hearing aid usage. Accordingly, obtaining the audio from the first audio source can include obtaining audio via at least one microphone of the first hearing aid and converting the audio into an audio signal representative of the audio.

In the case of a first environmental audio source, both the first hearing aid and the second hearing aid can obtain the audio signal from the first audio source. In certain examples, there may be minor variations of the audio signal obtained by the first hearing aid and the audio signal obtained from the second hearing aid. For example, there may be variations in the conversion of the audio to the audio signal in the first hearing aid and the second hearing aid. The first hearing aid can obtain the audio signal from the first audio source separately from the second hearing aid obtaining the audio signal from the first audio source. In other words, the first hearing aid can include a first microphone and the second hearing aid may include a second microphone, each receiving audio from the first audio source and converting it to respective audio signals. The audio signal obtained by the first hearing aid may be indicative of the same audio as the audio signal obtained by the second hearing aid. For example, if the first audio source is a person speaking, the first hearing aid and the second hearing aid obtain the audio signal of the current audio being spoken by the person speaking.

In one or more example methods, the method includes determining, by the first hearing aid, a first signal strength of the audio signal. In one or more example methods, the method includes determining, by the first hearing aid, a first signal strength of the signal representative of the audio. The first signal strength can be indicative of the strength of the audio signal received from the first audio source. The first signal strength can be indicative of the strength of the audio signal received at the first hearing aid.

In one or more example methods, the first signal strength can be indicative of a measurement of the quality or strength of the audio signal. In one or more example methods, the first signal strength can be indicative of a measurement of the quality or strength of a 2.4 GHz audio signal and could include one or more of received signal strength indicator (RSSI), averaged RSSI, and Bit Error Rate. The 2.4 GHz audio signal could be Standard Bluetooth, LE Audio, proprietary 2.4 GHz connection, and/or WiFi. The first signal strength can be indicative of temporal data. For example, the first signal strength can be indicative of time of flight. The first signal strength can be the first radio signal strength. The first signal strength can be the first radiofrequency signal strength.

The method can include obtaining, by a second hearing aid, an audio signal from the first audio source. In other words, the second hearing aid can obtain the same audio signal as the first hearing aid from the same source. For example, the second hearing aid and the first hearing aid can be working with one another for obtaining the audio signal.

The second hearing aid can be, for example, a hearing aid configured to be used with a right ear of a user (e.g., a right hearing aid, HAR). Obtaining the audio signal can include obtaining the audio via a microphone of the second hearing aid and converting it to the audio signal. Obtaining the audio can include obtaining the audio signal via a wireless communication, such as via an antenna. A wireless communication includes, for example, Bluetooth. Obtaining the audio signal can include converting audio, by the second hearing aid, into an audio signal (e.g., an electronic signal representative of the audio). Obtaining the audio signal can include converting the audio to an audio signal, such as an electronic signal, representative of the audio. As used herein, “audio” and “signal” can be used interchangeably.

In one or more example methods, the method includes determining, by the second hearing aid, a second signal strength of the audio signal. In one or more example methods, the method includes determining, by the second hearing aid, a second signal strength of the signal representative of the audio. The second signal strength can be indicative of the strength of the audio signal received from the first audio source. The second signal strength can be indicative of the strength of the audio signal received at the second hearing aid.

In one or more example methods, the method includes determining, by the first hearing aid, a second signal strength of the audio signal. In one or more example methods, the method includes determining, by the first hearing aid, a second signal strength of the signal representative of the audio signal. The second signal strength can be indicative of the strength of the audio signal received from the first audio source. The second signal strength can be indicative of the strength of the audio signal received at the second hearing aid. In other words, the first hearing aid can determine the first signal strength and the second signal strength.

In one or more example methods, the second signal strength can be indicative of a measurement of the quality or strength of the audio signal. In one or more example methods, the second signal strength can be indicative of a measurement of the quality or strength of a 2.4 GHz signal and could include one or more of received signal strength indicator (RSSI), averaged RSSI, and Bit Error Rate. The 2.4 GHz signal could be Standard Bluetooth, LE Audio, proprietary 2.4 GHz connection, and/or WiFi. The second signal strength can be indicative of temporal data. For example, the second signal strength can be indicative of time of flight. The second signal strength can be the second radio signal strength. The second signal strength can be the second radiofrequency signal strength.

The method can include obtaining the same audio signal by the first hearing aid and the second hearing aid from the same first audio source. However, the signal strength of the audio signal may vary depending on the positioning of the first hearing aid and the second hearing aid, which can lead to differences between the first signal strength and the second signal strength. For example, if a user's head is turned away from the first audio source, the first signal strength (e.g., of the first hearing aid closer to the first audio source) may be stronger than the second signal strength (e.g., of the second hearing aid farther from the first audio source).

In other words, both the first hearing aid and the second hearing aid can measure the signal strength of the same audio signal (e.g., of the same audio, even if the particular audio signal may have minor differences). For example, both the first hearing aid and the second hearing aid can measure the signal strength of audio signal from the same audio source (e.g., signal source), in this case the first audio source. Both the first hearing aid and the second hearing aid can obtain the same audio signal, but the strength of the received audio may vary. For example, the first hearing aid can be a left hearing aid and the second hearing aid can be a right hearing aid. The strength (as indicated by the first signal strength and the second signal strength) of the received audio signal may vary from left to right based on the line of sight of the streaming source. For example, the angle of the user's head relative to the first audio source may affect the signal strength.

In one or more example methods, the method includes comparing the second signal strength with the first signal strength for determination of a difference between the second signal strength and the first signal strength. The difference can be a difference in signal strength between the second signal strength and the first signal strength. The difference can be an absolute value (e.g., a positive value). The method can include comparing, by the first hearing aid, the second signal strength with the first signal strength for determination of a difference between the second signal strength and the first signal strength. The method can include comparing, by the second hearing aid, the second signal strength with the first signal strength for determination of a difference between the second signal strength and the first signal strength.

In one or more example methods, the method can include communicating the first signal strength and/or the second signal strength between the first hearing aid and the second hearing aid. For example, the method can include communicating between the first hearing aid and the second hearing aid via a binaural link. The method can include wirelessly communicating between the first hearing aid and the second hearing aid. The method can include transmitting (e.g., communicating), from the first hearing aid to the second hearing aid, the first signal strength. The method can further include transmitting, from the first hearing aid to the second hearing aid, the first signal strength.

In one or more example methods, the comparing is performed by the first hearing aid. In one or more example methods, the comparing is performed by the second hearing aid. In one or more examples, one of the first hearing aid and the second hearing aid can perform the comparing. In one or more example methods, the comparing is performed by a third device, such as a smartphone.

In one or more example methods, the method can allow for the first hearing aid to act as a master and the second hearing aid to act as a slave. For example, the method can include communicating the second signal strength from the second hearing aid to the first hearing aid.

In one or more example methods, in accordance with the difference between the first signal strength and the second signal strength meeting a difference criterion, the method can include changing (e.g., modifying, adjusting) at least one audio parameter in both the first hearing aid and the second hearing aid. In one or more example methods, in accordance with the difference between the first signal strength and the second signal strength meeting a difference criterion, the method can include changing at least one audio parameter in both the first hearing aid and the second hearing aid with relation to the first audio source. In one or more example methods, in accordance with the difference between the first signal strength and the second signal strength meeting a difference criterion, the method can include changing at least one audio parameter in both the first hearing aid and the second hearing aid with relation to a second audio source. As used herein, “with relation to” can include one or more of relating to, associated with, in association with, connected with, etc.

In one or more example methods, changing the at least one audio parameter in both the hearing aid and the second hearing aid includes changing the same at least one audio parameter in both the hearing aid and the second hearing aid. Advantageously, the method adjusts the at least one audio parameter in both the first hearing aid and the second hearing aid, allowing them to work in concert with one another.

In one or more example methods, in accordance with the difference between the first signal strength and the second signal strength meeting a difference criterion, the method can include changing at least one audio parameter in both the first hearing aid and the second hearing aid with relation to the audio signal. In one or more example methods, in accordance with the difference between the first signal strength and the second signal strength meeting a difference criterion, the method can include changing at least one audio parameter in both the first hearing aid and the second hearing aid with relation to a second audio signal. As used herein, “with relation to” can include one or more of relating to, associated with, in association with, connected with, etc.

Examples of at least one audio parameter can include one or more of gain levels, amplification, attenuation, and filtering. The at least one audio parameter can be a gain of an output of the first hearing aid and the second hearing aid (e.g., a gain applied to the audio signal and/or a second audio signal). The at least one audio parameter can be a volume of the first hearing aid and the second hearing aid. The at least one audio parameter can be a weighting of the audio signal of the first hearing aid and the second hearing aid. The at least one audio parameter can be a power level of the first hearing aid and the second hearing aid. The at least one audio parameter can be an output (e.g., an audio output).

In one or more example methods, in accordance with the difference between the first signal strength being and the second signal strength meeting a difference criterion, the method can include changing at least one audio parameter in both the first hearing aid and the second hearing aid from the first audio source to a second audio source. The at least one audio parameter can be the same in the first hearing aid and the second hearing aid. Accordingly, the method can change the same audio parameter in both the first hearing aid and the second hearing aid. This allows the first hearing aid and the second hearing aid to operate in the same (or similar) manner.

In one or more example methods, changing the at least one audio parameter in both the first hearing aid and the second hearing aid can include changing the gain applied to the audio signal. In one or more example methods, changing the at least one audio parameter in both the first hearing aid and the second hearing aid can include changing the gain applied to a second audio signal obtained by the first hearing aid and the second hearing aid. In one or more example methods, changing the at least one audio parameter in both the first hearing aid and the second hearing aid can include changing the gain applied to the audio signal and a second audio signal obtained by the first hearing aid and the second hearing aid.

In other words, the method changes at least one audio parameter in both the first hearing aid and the second hearing aid when the method determines that the user is not looking at the first audio source. This allows the user to achieve better sound quality based on where they may be looking. For example, the method allows for the modification of gain of a particular audio source (e.g., via changing the at least one audio parameter). For example, as a user turns their head away from a TV and towards a person, the method can reduce the gain (and/or attenuate) of audio signal received from the TV and increase the gain of the audio signal received from the person.

The second audio signal can be from (e.g., outputted by) a second audio source. The second audio signal can be from a second audio source that is the same type of audio source as the first audio source. In other words, both the first audio source and the second audio source can be streaming audio sources. The second audio signal can be from a second audio source that is a different type of audio source as the first audio source. In other words, the second audio source can be an environmental audio source and the first audio source can be a streaming audio source.

The second audio source can be a second streaming audio source. In other words, the second audio source can be an audio source connected to the first hearing aid via a wireless communication. For example, the second audio source can include one or more of: a television, a mobile telephone, a computer, a tablet, a TV adapter, an EduMic, and a smart phone. The first hearing aid can obtain the second audio signal from the second streaming audio source via wireless communication, such as Bluetooth. The second streaming audio source can be any device that actively streams the second audio signal to the first hearing aid. Accordingly, obtaining the second audio signal from the second audio source can include obtaining a signal representation of audio from the second audio source.

The second audio source can be a second environmental audio source. For example, the second audio source can be producing the second audio signal in the environment around a user of the hearing aid. The first hearing aid can obtain the audio from the second audio source via one or more microphones in the first hearing aid. This can be understood as being a standard hearing aid usage. Accordingly, obtaining the audio from the second audio source can include obtaining audio via at least one microphone of the first hearing aid and converting the audio into the second audio signal representative of the audio.

In one or more example methods, in accordance with the difference between the first signal strength and the second signal strength meeting a difference criterion, the method can include changing at least one audio parameter in both the first hearing aid and the second hearing aid from the first audio source to a second audio source. In other words, the first hearing aid and the second hearing aid can change “focus” from the first audio source to the second audio source. For example, changing at least one audio parameter in both the first hearing aid and the second hearing aid from the first audio source to a second audio source can include increasing gain of the second audio signal from the second audio source and reducing gain of the audio signal obtained from the first audio source. In one or more example methods, changing at least one audio parameter in both the first hearing aid and the second hearing aid from the first audio source to a second audio source can include stopping obtaining the audio signal from the first audio source and starting obtaining a second audio signal from the second audio source.

In one or more example methods, in accordance with the difference between the first signal strength and the second signal strength meeting a difference criterion, the method can include changing at least one audio parameter in both the first hearing aid and the second hearing aid related to (and/or associated with) the first audio source to an updated audio parameter related to (and/or associated with) second audio source.

In one or more example methods, changing at least one audio parameter in both the first hearing aid and the second hearing aid comprising changing the gain output representative of the first audio source and/or changing the gain output representative of the second audio source.

In one or more example methods, in accordance with the difference between the first signal strength and the second signal strength meeting a difference criterion, the method can include changing at least one audio parameter in both the first hearing aid and the second hearing aid from a first setting configured for the first audio source to a second setting configured for a second audio source. The first setting can provide an optimized output for the first audio source. The second setting can provide an optimized output for the second audio source.

In other words, the method can change the at least one audio parameter of the first hearing aid and the second hearing aid in order for the user to better hear and/or understand the second audio source. For example, the user could look away from a television (e.g., the first audio source) in order to participate in a conversation with a family member in the room (e.g., the second audio source). As the difference is indicative of the user looking away from the first audio source, for example focusing on the second audio source, it can be advantageous to adjust the at least one audio parameter of the first hearing aid and the second hearing aid to better allow the user to hear the second audio source. This can involve changing the gain of the first audio source and/or the second audio source (e.g., changing the gain on the audio signal and/or the second audio signal).

In one or more examples, the first audio source and the second audio source can both be streaming sources (e.g., a first streaming source and a second streaming source).

In one or more examples, the first audio source can be a streaming source and the second audio source can be an environmental audio source. In one or more examples, the second audio source can be a streaming source and the first audio source can be an environmental audio source.

In one or more example methods, changing at least one audio parameter in both the first hearing aid and the second hearing aid can include weighting the gain of the first audio source and the second audio source (e.g., weighting the gain on the audio signal and/or the second audio signal). For example, changing at least one audio parameter in both the first hearing aid and the second hearing aid can include increasing a gain of the audio signal and reducing a gain of the second audio signal.

In one or more example methods, the method can further include determining a distance of the first audio source and a second audio source. In one or more example methods, the method can include changing at least one audio parameter in both the first hearing aid and the second hearing aid can include weighting, based on the difference and the difference, the gain of the first audio source and the second audio source.

In other words, the method can allow for changing the gain of the first audio source and/or the second audio source based on the location of the first audio source and/or the second audio source and the direction that the user of the binaural hearing aid system is looking.

In one or more example methods, after the changing the at least one audio parameter, in both the first hearing aid and the second hearing aid, the method can adjust to a second audio source. For example, after the changing the at least one audio parameter, in both the first hearing aid and the second hearing aid, the method can include:
obtaining, by the first hearing aid, a second audio signal from a second audio source;
determining, by the first hearing aid, a third signal strength of the second audio signal;
obtaining, by the second hearing aid, the second audio signal from the second audio source;
determining, by the second hearing aid, a fourth signal strength of the second audio signal;
comparing the third signal strength with the fourth signal strength for determination of a difference between the third signal strength and the fourth signal strength; and
in accordance with the difference between the third signal strength and the fourth signal strength meeting the difference criterion, changing at least one audio parameter in both the first hearing aid and the second hearing aid.

In other words, the method can allow for a reset to a new audio source (e.g., the second audio source). The method can repeat itself with the new audio source.

The difference criterion can be, for example, a difference threshold. In one or more example methods, in accordance with the difference being greater than a difference threshold, the method includes determining the difference meets the difference criterion. In one or more example methods, in accordance with the difference being less than or equal to the difference threshold, the method includes determining the difference does not meet the difference criterion. For example, the difference threshold could be one of 5, 10, 15, 20, 25, 30, 35, or 40 dB. In one or more example methods, the difference threshold can be a static value. In one or more example methods, the difference threshold can be an adaptive value. In one or more example methods, the method can include changing, based on one or more parameters of the audio, the difference threshold.

In one or more example methods, in accordance with the difference being greater than a difference threshold for a time period, the method includes determining the difference meets the difference criterion. Advantageously, the use of a time period can prevent improper changing of the at least one audio parameter for short spikes audio levels of a given hearing aid. The time period can be, for example, 1, 2, 3, 4, or 5 seconds. In one or more example methods, in accordance with the difference not being greater than a difference threshold for a time period, the method includes determining the difference does not meet the difference criterion.

Having a time period below 1 second would give an extremely fast reacting system, where attention can be shifted rapidly, but may also entail that streaming audio would be attenuated unwanted in some scenarios when the user looks shortly in another direction (i.e. looking out the window), and would be less robust to signal noise (e.g., if the signal strength drops momentarily on one ear due to package loss, etc.). Setting it to above 5 seconds could have the opposite effect, where the user might have to wait a while for the hearing aid to shift the focus from one audio source to another, but it would mostly only happen when they want it to, also making it more robust to signal noise. Embodiments of the disclosed time period can be beneficial to allow the user to adjust this time period on their own using an app interface or alike. In one or more example embodiments, the method can include receiving user input to set the time period.

In accordance with the difference between the first signal strength being and the second signal strength not meeting the difference criterion, the method can include not changing at least one audio parameter in both the first hearing aid and the second hearing aid. For example, the method can include maintaining the at least one audio parameter.

In one or more example methods, the method can further include adjusting, based on the first signal strength and the second signal strength, the difference criterion. For example, a user may be looking away from the first audio source for a period of time, and it may be advantageous for the method to reset the baseline of the difference criterion to this off-centered positioning of the first hearing aid and the second hearing aid. In one or more example methods, the method can further include, in accordance with the difference meeting the difference criterion for a period of time, adjusting, based on the first signal strength and the second signal strength, the difference criterion.

In one or more example methods, changing the at least one audio parameter comprises attenuating the first audio source (e.g., attenuating the audio signal). In one or more example methods, changing the at least one audio parameter comprises attenuating the first audio source (e.g., attenuating the audio signal) in both the first hearing aid and the second hearing aid. In one or more example methods, changing the at least one audio parameter comprises attenuating the audio signal from first audio source. In one or more example methods, changing the at least one audio parameter comprises reducing a gain of the first audio source (e.g., reducing the gain of the audio signal). In one or more example methods, changing the at least one audio parameter comprises reducing a gain of the audio signal from the first audio source. In one or more example methods, changing the at least one audio parameter comprises increasing the gain of the second audio source (e.g., increasing the gain of the second audio signal). In one or more example methods, changing the at least one audio parameter comprises attenuating the second audio source (e.g., attenuating the second audio signal).

Advantageously, as the user may no longer be looking at the first audio source, and may be focused elsewhere, the method allows for the attenuation of the audio from the first audio source.

In one or more example methods, changing the at least one audio parameter comprises increasing gain of a second audio source (e.g., increasing gain of the second audio signal). In one or more example methods, changing the at least one audio parameter comprises increasing gain of the second audio signal from a second audio source.

Advantageously, a user may be looking towards the second audio source, and the method can improve the user's understanding of the second audio source.

In one or more example methods, changing the at least one audio parameter comprises changing the gain of the first audio source and/or changing the gain of the second audio source. In one or more example methods, changing the at least one audio parameter comprises changing the gain of the audio signal and/or changing the gain of the second audio signal.

In one or more example methods, changing the at least one audio parameter comprises attenuating the gain of the first audio source (e.g., the audio signal) and/or increasing the gain of the second audio source (e.g., the second audio signal).

Advantageously, this will allow the method to adaptively change the gain ratio between the first audio source (such as a streamed audio source) and the second audio source (such as a hearing aid microphone output) based on the attention of the user. For example, when the user is looking away, as indicated by the difference meeting the difference criterion, the method can change the at least one audio parameter by lowering the first audio source gain (e.g., streaming gain) and increasing the second audio source gain (e.g., microphone gain). Advantageously, this can allow the user to communicate with their surroundings in a more “seamless” way without having to switch between hearing aid modes or having to start/stop the stream. Vice versa it allows the user to focus on the streaming source audio when looking towards the source (e.g., TV).

In one or more example methods, determining the first signal strength comprises determining a first received signal strength indicator (RSSI) of the audio signal. In one or more example methods, determining the second signal strength comprises determining a second received signal strength indicator (RSSI) of the audio signal. In one or more example methods, determining the first signal strength comprises determining a first received signal strength indicator (RSSI) of the signal representative of the audio. In one or more example methods, determining the second signal strength comprises determining a second received signal strength indicator (RSSI) of the signal representative of the audio. Other types of signal strengths may be used. In one or more example methods, determining the first signal strength of the audio signal can comprise determining a first signal quality of the audio.

In one or more example methods, determining the first signal strength comprises determining the RSSI on all received packets. In one or more example methods, determining the second signal strength comprises determining the RSSI on all received packets. In one or more example methods, the first hearing aid and/or the second hearing aid may include an accelerometer. Obtaining the accelerometer data can include obtaining the accelerometer data from the accelerometer. The first hearing aid and/or the second hearing aid may include a gyroscope. The first hearing aid may include a first accelerometer and the second hearing aid may include a second accelerometer. In certain examples, the first accelerometer may obtain first accelerometer data. The second accelerometer may obtain second accelerometer data.

In one or more example methods, the method can include obtaining, by the first hearing aid and/or the second hearing aid, accelerometer data. In one or more example methods, the method can include determining, by the first hearing aid and/or the second hearing aid, accelerometer data. For example, the accelerometer data can be first accelerometer data form the first hearing aid and/or second accelerometer data from the second hearing aid. The accelerometer data can be the first accelerometer data, the second accelerometer data, or a combination of the first accelerometer data and the second accelerometer data. The accelerometer data can be indicative of movement of the first hearing aid. The accelerometer data can be indicative of movement of the second hearing aid. The accelerometer data can be indicative of movement of the first hearing aid and/or the second hearing aid.

In certain examples, the accelerometer data can be indicative of movement if the accelerometer data meets an accelerometer criterion. In certain examples, the accelerometer can be not indicative of movement if the accelerometer data does not meet an accelerometer criterion. In certain examples, the accelerometer can be indicative of movement if the accelerometer data meets an accelerometer threshold. In certain examples, the accelerometer can be not indicative of movement if the accelerometer data does not meet an accelerometer threshold.

In certain examples, if the accelerometer data is indicative of a movement of greater than 0.1 m/s, the method can determine that the accelerometer data meets the accelerometer criterion, and that the accelerometer data is indicative of movement.

In some example methods, the method can include applying a low-pass filter to the accelerometer data. Advantageously, this may reduce noise, and therefore reduce false notifications of movement from the accelerometer data.

In one or more example methods, the accelerometer data can be an accelerometer strength data. For example, the accelerometer data may provide acceleration data along three axes, and the accelerometer strength data can be a single numerical value representing a combination of the three axes.

The accelerometer data can be a velocity. The accelerometer criterion can be a velocity. The accelerometer data can be an acceleration. The accelerometer criterion can be an acceleration. The accelerometer data can be positive or negative. For example, positive accelerometer data can be indicative of a left turn and negative accelerometer data can be indicative of a right turn.

In one or more example methods, the accelerometer data may be normalized between 0-1, with 0 representing no acceleration and 1 representing high acceleration. In accordance with the acceleration data being at least 0.5, the method includes determining that the acceleration data is indicative of movement. In accordance with the acceleration data being at less than 0.5, the method includes determining that the acceleration data is not indicative of movement.

In one or more examples, the accelerometer data can be degrees per second. The acceleration criterion can be met above 50 degrees per second. In accordance with the acceleration data being at least 50 degrees per second, the method includes determining that the acceleration data is indicative of movement. In accordance with the acceleration data being at less than 50 degrees per second, the method includes determining that the acceleration data is not indicative of movement.

Other acceleration criteria can be used as well. For example, the acceleration criterion can be met in accordance with the accelerometer data being indicative of a velocity above 20, 30, 40, 50, 60, 70, or 80 degrees per second.

In one or more examples, the accelerometer data can be degrees per second. The acceleration criterion can be met above 50 degrees per second squared. In accordance with the acceleration data being at least 50 degrees per second squared, the method includes determining that the acceleration data is indicative of movement. In accordance with the acceleration data being at less than 50 degrees per second squared, the method includes determining that the acceleration data is not indicative of movement.

Other acceleration criteria can be used as well. For example, the acceleration criterion can be met above 50, 100, 150, or 200 degrees per second squared.

In certain examples, the method can include obtaining, by the first hearing aid and/or the second hearing aid, accelerometer data over a period of time. When the accelerometer data is indicative of a cumulative acceleration being over a cumulative threshold over the period of time, the method includes determining that accelerometer data is indicative of movement of the first hearing aid and/or the second hearing aid. When the accelerometer data is indicative of a cumulative acceleration being equal to or below a cumulative threshold over the period of time, the method includes determining that accelerometer data is indicative of movement of the first hearing aid and/or the second hearing aid.

Example periods of time can be 0.1, 0.2, 0.3, 0.4, 0.5, 0.6, 0.7, 0.8, 0.9, 1.0, 1.5, 2.0, or 3.0 seconds.

In accordance with the difference between the first signal strength being and the second signal strength meeting the difference criterion and the accelerometer data being indicative of movement of the first hearing aid and/or the second hearing aid, the method can include changing the at least one audio parameter in the first hearing aid and the second hearing aid. For example, the method may only change the at least one audio parameter if both the difference meets the difference criterion and the accelerometer data is indicative of movement of the first hearing aid and/or the second hearing aid. This may advantageously reduce improperly changing the at least one audio parameter in situations where it may not be necessary.

In accordance with the difference between the first signal strength being and the second signal strength not meeting the difference criterion or the accelerometer data not being indicative of movement of the first hearing aid and/or the second hearing aid, the method can include changing the at least one audio parameter in the first hearing aid and the second hearing aid.

In one or more example methods, changing the at least audio parameter comprises changing from a Bluetooth streaming mode to a hearing aid mode or changing from a hearing aid mode to a Bluetooth streaming mode.

The Bluetooth streaming mode can be one or more audio parameters of the first hearing aid and the second hearing aid to allow the user to better hear audio from a streaming audio source. For example, the Bluetooth streaming mode can be understood as receiving, by the binaural hearing system, an audio signal from an external device. The external device can be, for example, a TV, a phone, a computer. The Bluetooth streaming mode can be understood as receiving the audio signal via an antenna. The Bluetooth streaming mode can be understood as receiving the audio signal not from a microphone of the binaural hearing aid system. The Bluetooth streaming mode can be understood as audio signal received by the antenna having a higher gain than an audio signal received by a microphone of the binaural hearing system.

The hearing aid mode can be one or more audio parameters of the first hearing aid and the second hearing aid to allow the user to better hear audio from the environment through microphones of the first hearing aid and the second hearing aid. For example, the hearing aid mode can be understood as receiving, by the binaural hearing system, an audio signal from the environment around a user of the binaural hearing aid system. The hearing aid mode can be understood as receiving the audio signal via one or more microphones of the binaural hearing aid system. The hearing aid mode can be understood as receiving the audio signal not from an antenna of the binaural hearing aid system. The hearing aid mode can be understood as audio signal received by the one or more microphones having a higher gain than an audio signal received by an antenna of the binaural hearing system.

In one or more example methods, changing the at least audio parameter comprises changing comprises adjusting the relative gain of the first audio source and the second audio source.

In one or more example methods, determining the first signal strength comprises applying a filter to the audio signal. In one or more example methods, determining the second signal strength comprises applying the filter to the audio signal. The method can apply the same filter to both the first hearing aid and the second hearing aid. In one or more example methods, the filter is a median filter and/or a low-pass filter and/or a Kalman filter. In one or more example methods, the filter is a low-pass filter, i.e. a median filter, and/or a prediction filter, i.e. a Kalman filter. The type of filter is not limiting, and different filters can be used for different purposes. In one or more examples, applying a filter can include applying a plurality of filters. In one or more examples, applying a filter can include applying one or more filters. In one or more example methods, the median and/or mean filters can be categorized as low-pass filter. In one or more example methods, the filter can be a signal smoother. In one or more example methods, the filter can be an estimation and/or prediction filter. For example, the filter can be based on statistics and probabilities that can be used to further smooth the audio (such as the signal representative of the audio) by removing statistical noise.

Applying the filter can allow for the smoothing of the audio signal (e.g., smoothing of the signal representing the audio). For example, the filter can be used to remove signal outliers and artifacts. In certain examples, the filter can be used to remove the DC offset. In other words, the filtering can be used so that a signal level difference of around 0 (from left to right, or from the first hearing aid to the second hearing aid) will represent the look direction of the first audio source, and a level difference greater or smaller than 0 will represent looking away from the first audio source. The sign of the difference (e.g., negative or positive) can indicate the look direction (e.g., left or right, first hearing aid or second hearing aid).

In practice, even if most adverse effects are decreased by intelligent packet selection and level estimates, the resulting signal levels are very noisy and significantly affected by environmental factors such as other radiofrequency sources, reflections, and shadow fading. Therefore, applying the method applying additional signal filtering may be advantageous.

For example, applying the filter can eliminate as much as random variation in the signal as possible. Robust smoothing filters, such as a low-pass filters and median filters are advantageous to employ, as these will be able to eliminate some of the effects of noisy measured values with large magnitudes. A median filter operates by sorting the measured signal values and generating an output value which is the middle value of the sorted list. The median filter output can be calculated as:

$$y [ n ] = median ( x [ n ] , … , x [ n - T ] )$$

where n is the current sample and T is the length of the filter.

In order to assess the signal strength, the DC level is of most interest. Therefore, it can be beneficial to remove faster signal fluctuations using low pass filters. In practice, the low pass filter most suitable for application can be chosen based on the recorded signal characteristics, processing power limits, etc. Common types of lowpass filters to be used could include Butterworth filters, Chebyshev filters, and Bessel filters. A low-cost implementation of a low-pass filter could be a mean filter as shown below:

$$y [ n ] = mean ( x [ n ] , … , x [ n - T ] )$$

where n is the current sample and T is the length of the filter.

Furthermore, signal estimates could also be enhanced by using a prediction filter. One possible implementation of this could be a Kalman filter. The Kalman filter operates by using a series of equations to update the estimate of the measurement at each time step, based on the previous estimate, the control inputs, and the raw measurements. It can be used to filter out noise and eliminate errors in the raw measurements, resulting in a more accurate estimate of the true values of the measurements.

The basic equations for a Kalman filter consist of two steps—the prediction step and the update step.

### Prediction Step:

At each time step, the Kalman filter uses the previous estimate of the state of the system (x(k−1)) and the control inputs (u(k)) to predict the current state of the system (x(k))

$$x ( k ) = F ( k ) \cdot x ( k - 1 ) + B ( k ) \cdot u ( k ) + w ( k )$$

where F(k) is the state transition matrix, B(k) is the control input matrix, and w(k) is the process noise.

### Update Step:

After the prediction step, the Kalman filter uses the measurements of the state of the system (z(k)) to update the estimate of the current state (x(k))

$$x ( k ) = x ( k ) + K ( k ) \cdot ( z ( k ) - H ( k ) \cdot x ( k ) )$$

where K(k) is the Kalman gain, H(k) is the measurement matrix, and z(k)−H(k)*x(k) is the measurement residual.

The Kalman gain is calculated as follows:

$$K ( k ) = P ( k ) \cdot H ( k ) T \cdot {( H ( k ) \cdot P ( k ) \cdot H ( k ) T + R ( k ) )}^{- 1}$$

where P(k) is the estimate of the state covariance matrix and R(k) is the measurement noise covariance matrix.

These equations form the core of the Kalman filter algorithm and are the main equations that are used to update the estimate of the state of the system based on the measurements.

In one or more example methods, obtaining, by the first hearing aid, the audio signal comprises obtaining, by the first hearing aid, the audio signal from a first plurality of channels. In one or more example methods, determining the first signal strength comprises determining, by the first hearing aid, a first average signal strength for each channel of the first plurality of channels. In one or more example methods, obtaining, by the second hearing aid, the audio signal comprises obtaining, by the second hearing aid, the audio signal from a second plurality of channels. In one or more example methods, determining, by the second hearing aid, the second signal strength comprises determining, by the second hearing aid, a second average signal strength for each channel of the second plurality of channels. In one or more example methods, comparing the second signal strength with the first signal strength comprises comparing the first average signal strength with the second average signal strength.

In one or more example methods, obtaining, by the first hearing aid, the audio signal comprises obtaining, by the first hearing aid, the audio signal from a first plurality of channels. In one or more example methods, determining the first signal strength comprises determining, by the first hearing aid, a first average signal strength for the first plurality of channels. In one or more example methods, obtaining, by the second hearing aid, the audio signal comprises obtaining, by the second hearing aid, the audio signal from a second plurality of channels. In one or more example methods, determining, by the second hearing aid, the second signal strength comprises determining, by the second hearing aid, a second average signal strength for the second plurality of channels. In one or more example methods, comparing the second signal strength with the first signal strength comprises comparing the first average signal strength with the second average signal strength.

In other words, the first hearing aid can obtain the audio signal via a number of different channels (e.g., a first plurality of channels). Similarly, the second hearing aid can obtain the audio signal via the second plurality of channels. The first plurality of channels can be the same type of channels as the second plurality of channels. For example, the indexes of the first plurality of channels and the second plurality of channels would be the same. For example, both the first plurality of channels and the second plurality of channels can be the same channels, just for the respective first hearing aid and second hearing aid. In one or more examples, the first plurality of channels and/or the second plurality of channels is composed of 37 channels. In one or more examples, the first plurality of channels and/or the second plurality of channels can be composed of up to 37 channels. However, the number of the first plurality of channels and/or the second plurality of channels can vary depending on the protocols of the audio signal.

In one or more example methods, determining the first signal strength comprises removing channels of the plurality of first channels having a fading effect greater than a fading effect threshold. In one or more example methods, determining the second signal strength comprises removing channels of the plurality of second channels having a fading effect greater than the fading effect threshold. Advantageously, by utilizing the fading effect threshold, the method can compensate for situations which have reverb and/or reflections.

For example, the audio signal will have multiple path routes to the first hearing aid and the second hearing aid: direct path, reflected from walls, creeping on skin, etc. This means the same audio will arrive at the first hearing aid and the second hearing aid in different phases. The multi-path sum will be seen as variation in amplitude/RSSI-level, referred to as the fading effect. This fading effect can be different for each of the channels used in Bluetooth LE. RSSI can be saved as an RSSI average on each channel, to enable channel to channel compare (left vs. right device). This enables a dynamic removal of channels with highest fading effect, making the RSSI more stable/correct. RSSI average (in each channel), can be optimized for best compromise between stable signal vs. reaction speed (head turn).

In one or more example methods, obtaining, by the first hearing aid, the signal comprises obtaining, by the first hearing aid, the audio signal from a first plurality of channels. In one or more example methods, determining, by the first hearing aid, the first signal strength comprises determining, by the first hearing aid, an individual first signal strength for each channel of the first plurality of channels. In one or more example methods, obtaining, by the second hearing aid, the signal comprises obtaining, by the second hearing aid, the audio signal from a second plurality of channels. In one or more example methods, determining, by the second hearing aid, the second signal strength comprises determining, by the second hearing aid, an individual second signal strength for each channel of the second plurality of channels. In one or more example methods, comparing the first signal strength with the second signal strength comprises comparing each of the individual first signal strength with a corresponding one of the individual second signal strength. In other words, the comparison can be made for the respective signal strengths of each channel of the plurality of channels.

In one or more example methods, the method can, instead of changing at least one parameter in both the first hearing aid and the second hearing aid, change the at least one parameter of one of the first hearing aid or the second hearing aid. This can allow for the method to apply binaural gain and delay differences between hearing aids, which may give a spatial representation of the first audio source location.

Further disclosed herein is a binaural hearing aid system configured to perform the method(s) disclosed herein. The binaural hearing aid system can include a first hearing aid and a second hearing aid. The first hearing aid and the second hearing aid can be configured to wirelessly communicated with one another.

The method, and accordingly the binaural hearing aid system, may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aids (e.g., the first hearing aid and/or the second hearing aid) may comprise a signal processor for enhancing the input signals and providing a processed output signal.

The hearing aids (e.g., the first hearing aid and/or the second hearing aid) may comprise an output unit for providing a stimulus perceived by the user as an acoustic signal based on a processed electric signal (e.g., such as a processed audio signal). The output unit may comprise a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aids (e.g., the first hearing aid and/or the second hearing aid) may comprise an input unit for providing an electric input signal (e.g. signal) representing audio (e.g. sound). The input unit may comprise an input transducer, e.g. a microphone, for converting an input sound to an audio signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aids (e.g., the first hearing aid and/or the second hearing aid) may comprise a directional microphone system adapted to spatially filter sounds from the environment, and thereby enhance a target acoustic source among a multitude of acoustic sources in the local environment of the user wearing the hearing aids. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The hearing aids (e.g., the first hearing aid and/or the second hearing aid) may comprise antenna and transceiver circuitry allowing a wireless link to a streaming audio source, such as an entertainment device (e.g. a TV-set), a communication device (e.g. a telephone), a wireless microphone, a separate (external) processing device, or another hearing aid, etc. The hearing aids (e.g., the first hearing aid and/or the second hearing aid) may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aids (e.g., the first hearing aid and/or the second hearing aid) can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aids (e.g., the first hearing aid and/or the second hearing aid) may comprise a ‘forward’ (or ‘signal’) path for processing an audio signal between an input and an output of the respective hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

The hearing aids (e.g., the first hearing aid and/or the second hearing aid) may further comprise other relevant functionality for the application in question, e.g. compression, noise reduction, etc.

The hearing aids (e.g., the first hearing aid and/or the second hearing aid) may comprise a hearing instrument, e.g. a hearing instrument adapted for being located at the ear or fully or partially in the ear canal of a user.

### A Computer Readable Medium or Data Carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

For example, disclosed herein is a tangible computer-readable medium (a data carrier) storing a computer program comprising program code means (instructions) for causing a data processing system (a computer) to obtain, by a first hearing aid, an audio signal from a first audio source, determine, by the first hearing aid, a first signal strength of the audio signal, obtain, by a second hearing aid, the audio signal from the first audio source, determine, by the second hearing aid, a second signal strength of the audio signal, compare the second signal strength with the first signal strength for determination of a difference between the second signal strength and the first signal strength; and in accordance with the difference between the first signal strength being and the second signal strength meeting a difference criterion, change at least one audio parameter in both the first hearing aid and the second hearing aid.

### A Computer Program:

A computer program (product) comprising instructions which, when the program is executed by a computer, cause the computer to carry out (steps of) the method described above, in the ‘detailed description of embodiments’ and in the claims is furthermore provided by the present application.

For example, disclosed herein is a computer program (product) comprising instructions which, when the program is executed by a computer, cause the computer to carry out obtaining, by a first hearing aid, an audio signal from a first audio source, determining, by the first hearing aid, a first signal strength of the audio signal, obtaining, by a second hearing aid, the audio signal from the first audio source, determining, by the second hearing aid, a second signal strength of the audio signal, comparing the second signal strength with the first signal strength for determination of a difference between the second signal strength and the first signal strength, and in accordance with the difference between the first signal strength being and the second signal strength meeting a difference criterion, changing at least one audio parameter in both the first hearing aid and the second hearing aid.

### A Data Processing System:

In an aspect, a data processing system comprising a processor and program code means for causing the processor to perform at least some (such as a majority or all) of the steps of the method described above, in the ‘detailed description of embodiments’ and in the claims is furthermore provided by the present application.

For example, disclosed herein is a data processing system comprising a processor and program code means for causing the processor to perform obtaining, by a first hearing aid, an audio signal from a first audio source, determining, by the first hearing aid, a first signal strength of the audio signal, obtaining, by a second hearing aid, the audio signal from the first audio source, determining, by the second hearing aid, a second signal strength of the audio signal, comparing the second signal strength with the first signal strength for determination of a difference between the second signal strength and the first signal strength, and in accordance with the difference between the first signal strength being and the second signal strength meeting a difference criterion, changing at least one audio parameter in both the first hearing aid and the second hearing aid.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIGS. 1A-IC illustrate different positions of a binaural hearing aid system of a user,

FIG. 2 illustrates signal paths experienced by a user of a binaural hearing aid system according to the disclosure,

FIGS. 3A-3B illustrate a particular scenario using an embodiment of the disclosed method,

FIGS. 4A-4B illustrate a particular scenario using an embodiment of the disclosed method,

FIG. 5 illustrates an example method according to the disclosure, and

FIG. 6 illustrates an example signal strength graph according to the disclose.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids, in particular to methods for operating binaural hearing aid systems.

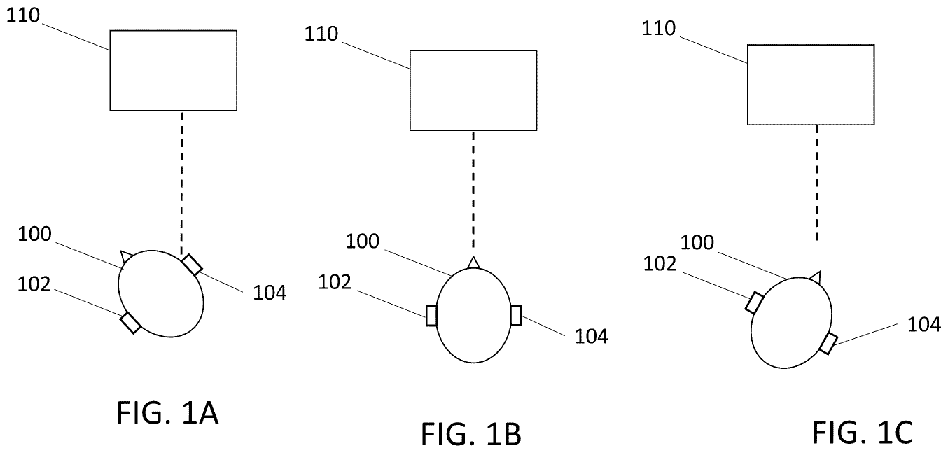

FIGS. 1A-IC illustrate different positions of a binaural hearing aid system of a user 100, such as used with the disclosed method(s). FIG. 1A shows the first hearing aid 102 (e.g., left hearing aid) shaded by the user's head while obtaining an audio signal from the first audio source 110, while the second hearing aid 104 (e.g., right hearing aid) is obtaining an audio signal from the first audio source 110 (e.g., television) with direct line of sight, and therefore will have a better signal strength than the first hearing aid 102 (e.g., in a comparison of the first signal strength and the second signal strength). FIG. 1B shows a scenario in which both hearing aids 102/104 will have approximately equal signal levels. FIG. 1C illustrates a scenario which is reversed from FIG. 1A.

As the user transitions from the different positions in FIGS. 1A-IC, the user 100 may be listening to different audio sources (e.g., first audio source 110 and second audio source). Further, in certain examples, accelerometer data can be used for indication of movement of the first hearing aid 102 and/or the second hearing aid 104. Accordingly, it can be advantageous to adjust at least one audio parameter in both the first hearing aid 102 and the second hearing aid 104. For example, it can be advantageous to adjust the gains on an audio signal from the first audio source 110 and/or a second audio signal from the second audio source to improve the hearing ability of the user 100.

In FIGS. 1A and 1C, the difference between the first signal strength and the second signal strength would meet the difference criterion. In FIG. 1B, the difference between the first signal strength and the second signal strength would not meet the difference criterion.

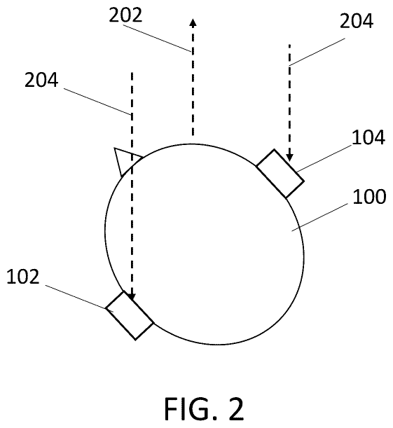

FIG. 2 illustrates signal paths experienced by a user of a binaural hearing aid system. By comparing signal levels between the first hearing aid 102 and the second hearing aid 104 and looking at how they can change over time, the disclosed method(s) can measure which direction the television is with respect to the user 100. Direction 202 illustrates where the first audio source is located. As shown, the second hearing aid 104 obtains a direct audio signal 204 whereas the first hearing aid 102 obtains the audio signal 204 through the user's head. Accordingly, the difference between the first signal strength and the second signal strength would meet the difference criterion. This can allow the method to change at least one audio parameter of both the hearing aids 102/104.

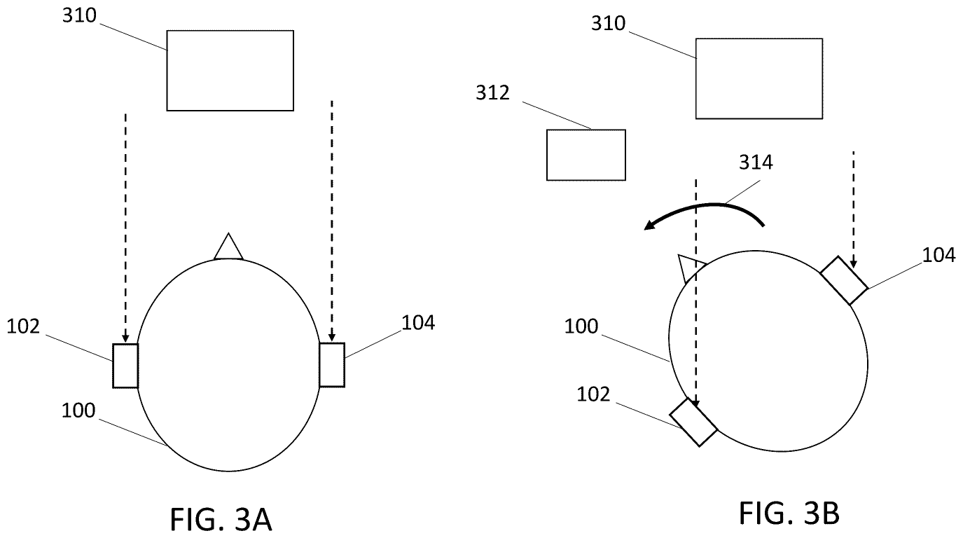

FIGS. 3A-3B illustrate a particular scenario using an embodiment of the disclosed method. After signal filtering and smoothing of Bluetooth signal levels on each of the first hearing aid 102 and the second hearing aid 104, the binaural signal level difference (e.g., the difference between the first signal strength and the second signal strength) can be analyzed.

In FIG. 3A, the user 100 is looking directly at the first audio source 310 (e.g., TV or other streaming source) whereas in FIG. 3B the user 100 has turned their head and is looking away from the first audio source 310, such as towards a second audio source 312. The signal strength determined by the first hearing aid 102 and the second hearing aid 104 is indicated by the length of the arrows, where a longer arrow signifies a weaker signal as the audio and/or signal must travel a longer distance between the streaming source and the respective hearing aids. From this it can be seen when comparing scenario of FIG. 3A to scenario of FIG. 3B, the binaural difference between the signal strengths will change. In general, the difference in scenario of FIG. 3A will have a lower amplitude (be closer to 0) than for scenario of FIG. 3B.

As an example, the user 100 could be watching television and receiving a streaming audio signal from the first audio source 310 as shown in FIG. 3A. The user 100 is looking directly at the first audio source, and the first signal strength and the second signal strength would not meet the difference criterion. Accordingly, the method takes no further action.

A person in the room (e.g., second audio source 312) begins speaking to the user 100, and the user 100 turns 314 his head towards the person (e.g., the second audio source 312) as shown in FIG. 3B. Now, the difference between the first signal strength and the second signal strength would meet the difference criterion. Further the acceleration data is indicative of movement of the first hearing aid and/or the second hearing aid (e.g., head turn 314). Thus, the method changes at least one audio parameter in both the first hearing aid 102 and the second hearing aid 104. Specifically, the method can attenuate the first audio source 310 and increase the gain of the second audio source 312. This allows the user 100 to better listen to the person (e.g., the second audio source 312).

Based on this difference, the implementation could look like the following:
1. The method determines, by the first hearing aid 102, the signal strength of the audio signal (e.g., the first signal strength of the first audio source 310). This creates a data point of the first hearing aid 102.
2. The data point from step 1 is sent over the binaural link to the second hearing aid 104.
3. The second hearing aid 104 will perform step 1 in the same way as first hearing aid 102 and compare the signal level from first hearing aid 102 received from step 2 (e.g., first signal strength) with its own signal level (e.g., second signal strength) over the same time period.
4. If the difference between the two does not meet the difference criterion, the method will indicate that the user 100 is looking at the streaming source (e.g., the first audio source 310, and that no change in at least one audio parameter is needed.
5. If the second signal strength>first signal strength (e.g., if the difference meets the difference criterion), the user 100 is looking left, and the method includes changing at least one audio parameter.
6. If second signal strength<first signal strength (e.g., if the difference meets the difference criterion), the user is looking right, and the method includes changing at least one audio parameter.

Based on the quality and stability of the signal strength indicators calculated at each of the hearing aids, the head turn detection could be calculated in discrete steps based on the angle of the head turn. Thereby, differences in signal levels could yield an angular estimate of the head angle relative to the first audio source. This may allow for adjustment of the difference criterion in order to improve the ability of the binaural hearing aid system to operate in a most efficient manner.

The estimation of head angle and head turns can be used for binaural spatialization of incoming streamed sound signals to both the first hearing aid and the second hearing aid. It can also be used to control the gain (e.g., change the at least one audio parameter) on either or both the first hearing aid 102 and the second hearing aid 104 when the user 100 is looking at or away from the first audio source 310. Additionally, establishing a reference point of the first audio source 310 can be used control and correct the head angle and head turn estimates of other sensors in the first hearing aid 102 and the second hearing aid 104, such as an accelerometer and/or a gyroscope.

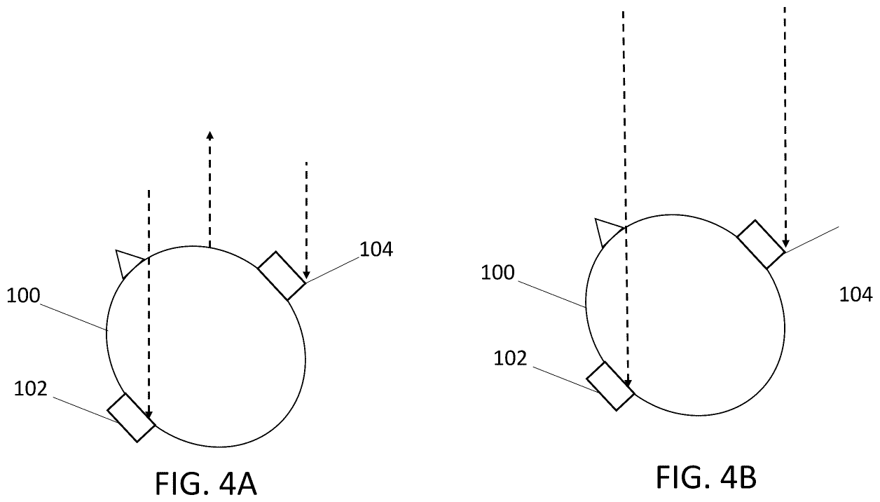

FIGS. 4A-4B illustrate an example scenario for estimating distance. The difference in binaural signal strength can also be used to estimate the distance between the user and the first audio source. The overall level of the signal strength of both the first hearing aid 102 and the second hearing aid 104 should both change equally if the user 100 moves closer to or away from the first audio source, as shown in FIGS. 4A-4B.

The arrow indicates the length that the signal must travel, therefore, a longer arrow will result in a lower signal strength due to attenuation. The signal strength to both the first hearing aid 102 and the second hearing aid 104 will be increased when the user 100 is closer to the first audio source in FIG. 4A as compared to FIG. 4B. The relative change in signal strength when the user 100 is moving away from the first audio source will be stronger than the measurable difference used for detection of head turns described above. Furthermore, using the binaural link it can be verified that the change in signal strength is similar in both the first hearing aid 102 and the second hearing aid 104.

Based on the application type, the method can average the signal strength received across both the first hearing aid 102 and the second hearing aid 104 and to compare the averaged measurement to, for example, a lookup table where signal strength could be converted into discrete steps of distance. Given that the signal strength is measured in power dB, an example of such a conversion can be seen in Table 1.

TABLE 1

| Average Power [dB] | Distance to Streaming Source |
|---|---|
| >−40 dB | Very close |
| 40 to-50 dB | Close |
| 50 to-60 dB | Average |
| 60 to-70 dB | Far |
| <−70 dB | Very Far |

The information of how far away the user 100 is from the streaming source could be used for various applications for the methods disclosed herein. It could be used for adaptive control of the gain, i.e., to decrease the streaming gain in discrete steps when the user 100 moves away from the first audio source. It could also be used to simulate room acoustics, where a longer distance between the user and the first audio source could infer the size of the room where the user 100 was sitting, and this size could be utilized in applying reverberation/room acoustics to the audio signal. If the user 100 is connected to multiple audio sources, the distance could also be used to switch between these automatically if the current active audio source signal strength drops significantly compared to other available audio sources. This would allow the user 100 to listen to the audio source they are closest to without having to switch manually between these.

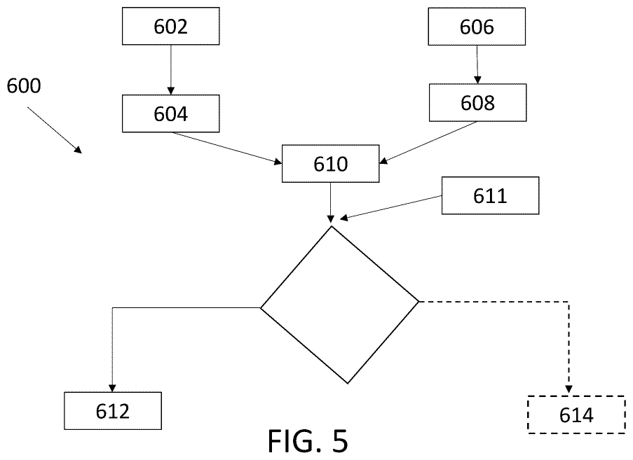

FIG. 5 illustrates an example method according to the disclosure. Specifically, FIG. 5 illustrates a method 600 for adjusting audio sources of a binaural hearing aid system. The method 600 includes obtaining 602, by a first hearing aid, an audio from a first audio source. The method 600 includes determining 604, by the first hearing aid, a first signal strength of the audio. The method 600 includes obtaining 606, by a second hearing aid, the audio from the first audio source. The method 600 includes determining 608, by the second hearing aid, a second signal strength of the audio. The method 600 includes comparing 610 the second signal strength with the first signal strength for determination of a difference between the second signal strength and the first signal strength. In accordance with the difference between the first signal strength being and the second signal strength meeting a difference criterion, the method 600 includes changing 612 at least one audio parameter in both the first hearing aid and the second hearing aid from the first audio source to a second audio source. In accordance with the difference between the first signal strength being and the second signal strength not meeting a difference criterion, the method 600 includes not changing 614 at least one audio parameter in both the first hearing aid and the second hearing aid.

The method 600 includes obtaining 611, by the first hearing aid and/or the second hearing aid, accelerometer data. In accordance with the difference between the first signal strength being and the second signal strength meeting the difference criterion and the accelerometer data being indicative of movement of the first hearing aid and/or the second hearing aid, changing 612 the at least one audio parameter in the first hearing aid and the second hearing aid. In accordance with the difference between the first signal strength being and the second signal strength meeting not the difference criterion or the accelerometer data not being indicative of movement of the first hearing aid and/or the second hearing aid, not changing 612 the at least one audio parameter in the first hearing aid and the second hearing aid.

In certain examples, changing 612 the at least one audio parameter comprises attenuating the audio signal of the first audio source. In certain examples, changing 612 the at least one audio parameter comprises increasing gain of a second audio signal of a second audio source.

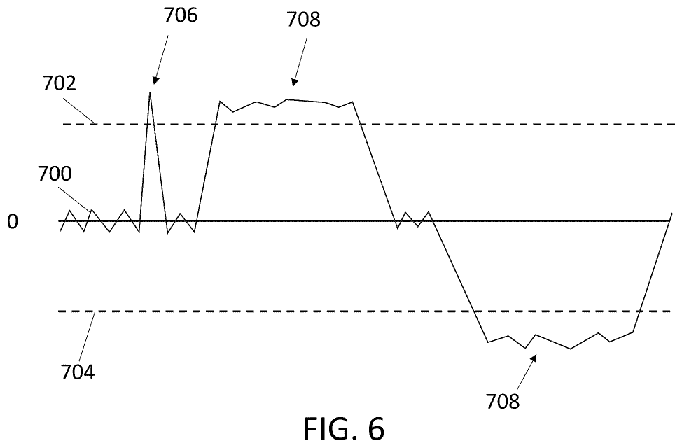

FIG. 6 illustrates an example signal strength graph according to the disclosure, between a positive value and a negative value. The graph illustrates the difference 700 determined by the method. When the difference 700 is between the positive threshold 702 and the negative threshold 704, it can be considered to not meet the difference criterion. Therefore, the at least one audio parameter would not be changed. Once the difference 700 exceeds either threshold 702/702, the difference 700 would meet the difference criterion. In one or more example methods, the method can utilize a time period as well, so that short spikes 706 would not lead to the difference 700 meeting the difference criterion. Instead, it would take longer times, such as shown as 708, for the difference 700 to meet the difference criterion. The thresholds, such as positive threshold 702 and/or negative threshold 704 can be static values. The thresholds, such as positive threshold 702 and/or negative threshold 704 can be adaptive thresholds. For example, the thresholds, such as positive threshold 702 and/or negative threshold 704 can change adaptively based on signal characteristics, statistics, etc.

Embodiments of the disclosed method(s) can follow certain steps in certain implementations.
1. Acquire RSSI signal levels from each hearing aid from a first audio source (e.g., determining the first signal strength and the second signal strength after obtaining the audio by the first hearing aid and the second hearing aid). Levels can be measured in the plurality of channels, for example each operating at a specific frequency.
2. Optionally, each of the plurality of channels of RSSI signal levels can be smoothed using a mean filter or other filter (e.g., applying a filter to the audio).
3. The RSSI level difference between each of the plurality of channels are computed (left−right), yielding in the plurality of channels of binaural RRSI level differences (e.g., comparing the second signal strength with the first signal strength).
4. A subset of the best performing channels can be picked for further processing. The “best” channels can be defined by those that show the least amount of fading/artifact characteristics.
   a. Estimated measure of fading/artifacts in each channel can be based on various statistical timeseries measurements and is most commonly either a single or combination of mean, variance, median, etc. Example of this could be to perform channels selection based on Median Absolute Deviation.
   b. The number of channels to select for further processing can either be a fixed amount of a number of channels (e.g., an amount lower than the total available channels) or adaptive based on thresholding of the fading/artifact measurements.
5. The remaining number of channels can be post-processed into a single channel which is a combination of these channels. The combination of post-filtering can include:
   a. All remaining channels are median, mean or Kalman filtered. Several of these filters can be applied by cascading these filters in any order desired.
   b. The filtered signal channels can be combined into a single channel/measurement by taking the mean of these.
   c. In certain embodiments, the resulting single channel measurement can be further smoothed by using the same methods as under step a. (median/mean/Kalman or similar filtering methods).
   d. Finally, the DC offset value of the signal can be removed. This is done using either by subtracting the mean or the median of the signal over a predefined length of the signal.
6. The overall smoothed binaural RSSI signal level difference produced in step 5 can be used for control of the hearing aid parameters, such as streaming signal and hearing aid signal gains.
   a. The at least one audio parameter can be controlled based on an estimation of if the hearing aid user is looking “towards” or “away” from the streaming source. If the user is looking towards the streaming source, the difference levels will drift towards 0. If they are looking away, the values will drift away from 0.
      i. The “difference criterion” thresholds for estimating look direction (“towards” vs “away”) can either be based on a predefined value but can also contain signal statistics such as the signal standard deviation.
      ii. When detecting “away”, the look direction can further be specified by looking at the sign of the binaural level difference. If left−right is used as stated in step 3, a negative sign will indicate that the user is looking “away” from the streaming source in the left direction, and in the right direction if the sign is positive (the hearing aid most affected by head shadow will have the weakest signal strength).
      iii. In general, when looking “away” from the streaming source, hearing aid gain will be increased, and streaming source gain will be decreased (for both hearing aids). The opposite will happen when looking “towards” the TV.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure.

The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A method for adjusting audio sources of a binaural hearing aid system, the method comprising:
obtaining, by a first hearing aid, an audio signal from a first audio source;
determining, by the first hearing aid, a first signal strength of the audio signal;
obtaining, by a second hearing aid, the audio signal from the first audio source;
determining, by the second hearing aid, a second signal strength of the audio signal;
comparing the second signal strength with the first signal strength for determination of a difference between the second signal strength and the first signal strength;
obtaining, by the first hearing aid and/or the second hearing aid, accelerometer data;
in accordance with the difference between the first signal strength being and the second signal strength meeting the difference criterion and the accelerometer data being indicative of movement of the first hearing aid and/or the second hearing aid, changing the at least one audio parameter in the first hearing aid and the second hearing aid,
wherein changing the at least one audio parameter comprises attenuating the audio signal of the first audio source, and
wherein changing the at least one audio parameter comprises increasing gain of a second audio signal of a second audio source.

2. Method of claim 1, wherein determining the first signal strength comprises determining a first received signal strength indicator (RSSI) of the audio signal and determining the second signal strength comprises determining a second received signal strength indicator (RSSI) of the audio signal.

3. Method of claim 1, further comprising communicating the first signal strength and/or the second signal strength between the first hearing aid and the second hearing aid.

4. Method of claim 1, wherein changing the at least audio parameter comprises changing from a Bluetooth streaming mode to a hearing aid mode or changing from a hearing aid mode to a Bluetooth streaming mode.

5. Method of claim 1, wherein determining the first signal strength comprises applying a filter to the audio signal, and wherein determining the second signal strength comprises applying the filter to the audio signal.

6. Method of claim 5, wherein the filter is a median filter and/or a low-pass filter and/or a Kalman filter.

7. Method of claim 1, wherein, in accordance with the difference being greater than a difference threshold, the method includes determining the difference meets the difference criterion.

8. Method of claim 7, wherein, in accordance with the difference being greater than a difference threshold for a time period, the method includes determining the difference meets the difference criterion.

9. Method of claim 1, wherein obtaining, by the first hearing aid, the audio signal comprises obtaining, by the first hearing aid, the audio signal from a first plurality of channels, wherein determining the first signal strength comprises determining, by the first hearing aid, a first average signal strength for each channel of the first plurality of channels, wherein obtaining, by the second hearing aid, the audio signal comprises obtaining, by the second hearing aid, the audio signal from a second plurality of channels, wherein determining, by the second hearing aid, the second signal strength comprises determining, by the second hearing aid, a second average signal strength for each channel of the second plurality of channels, and wherein comparing the second signal strength with the first signal strength comprises comparing the first average signal strength with the second average signal strength.

10. Method of claim 9, wherein determining the first signal strength comprises removing channels of the plurality of first channels having a fading effect greater than a fading effect threshold, and wherein determining the second signal strength comprises removing channels of the plurality of second channels having a fading effect greater than the fading effect threshold.

11. Method of claim 1, wherein:
obtaining, by the first hearing aid, the signal comprises obtaining, by the first hearing aid, the audio signal from a first plurality of channels;
determining, by the first hearing aid, the first signal strength comprises determining, by the first hearing aid, an individual first signal strength for each channel of the first plurality of channels;
obtaining, by the second hearing aid, the signal comprises obtaining, by the second hearing aid, the audio signal from a second plurality of channels;
determining, by the second hearing aid, the second signal strength comprises determining, by the second hearing aid, an individual second signal strength for each channel of the second plurality of channels; and
comparing the first signal strength with the second signal strength comprises comparing each of the individual first signal strength with a corresponding one of the individual second signal strength.

12. A binaural hearing aid system configured to:
obtain, by a first hearing aid, an audio signal from a first audio source;
determine, by the first hearing aid, a first signal strength of the audio signal;
obtain, by a second hearing aid, the audio signal from the first audio source;
determine, by the second hearing aid, a second signal strength of the audio signal;
compare the second signal strength with the first signal strength for determination of a difference between the second signal strength and the first signal strength;
obtain, by the first hearing aid and/or the second hearing aid, accelerometer data;
in accordance with the difference between the first signal strength being and the second signal strength meeting the difference criterion and the accelerometer data being indicative of movement of the first hearing aid and/or the second hearing aid, change the at least one audio parameter in the first hearing aid and the second hearing aid,
wherein to change the at least one audio parameter comprises to attenuate the audio signal of the first audio source, and
wherein to change the at least one audio parameter comprises to increase gain of a second audio signal of a second audio source.
